(19) United States
(12) Patent Application Publication
(10) Pub. No.: US 2026/0349884 A1
(43) Pub. Date: Nov. 5, 2026

(54) EFFICIENT BACKUPS FOR A SNAPSHOT OPTIMIZED FILE SYSTEM

(71) Applicant: Oracle International Corporation, Redwood Shores, CA (US)

(72) Inventors: Siddharth Choudhary, Belmont, CA (US); Jingtao Xu, Fremont, CA (US); Vyomkesh Tripathi, Fremont, CA (US); Gaurav Chadha, San Mateo, CA (US); Yang Li, San Francisco, CA (US); Alberto Embarcadero, Zapopan (MX); Nilesh Choudhury, Redwood City, CA (US)

(21) Appl. No.: 19/313,226

(22) Filed: Aug. 28, 2025

Related U.S. Application Data
(60) Provisional application No. 63/797,559, filed on Apr. 30, 2025.

(51) Int. Cl. G06F 11/1446

(52) U.S. Cl. CPC G06F 11/1469; G06F 2201/84

(57) ABSTRACT

Mechanisms are provided for generating backups for a snapshot optimized sparse-aware file system. The mechanisms initiate a backup of at least one file in the snapshot optimized sparse-aware file system and generate a snapshot of the at least one file. The snapshot is a sparse-aware snapshot storing only changes to the at least one file since a previous snapshot of the at least one file, and sparsity information. The mechanisms generate a backup object based on the snapshot, at least by storing the change data of the snapshot in the backup object, and representing the sparsity information of the snapshot as one or more logical offsets in the backup object. This backup object is stored in a backup storage for later use in restoring the at least one file.

### BENEFIT CLAIM

This application claims the benefit of Provisional Application 63/797,559, filed Apr. 30, 2025, the entire contents of which is hereby incorporated by reference as if fully set forth herein, under 35 U.S.C. § 119(e).

### INCORPORATION BY REFERENCE

The present application incorporates herein by reference the commonly owned U.S. Pat. No. 11,983,076, entitled “Clone-Aware Backup and Restore”, issued May 14, 2024 and U.S. patent application Ser. No. 18/885,231, entitled “Database Aware, Space Efficient, High Performance, Snapshots on Hyper-Scale Distributed Storage”, filed Sep. 13, 2024, in their entirety.

### FIELD OF THE INVENTION

The illustrative embodiments of the present invention are directed to sparse aware, network and space efficient backups for snapshot optimized file systems.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Contemporary data storage environments are increasingly required to accommodate large volumes of data while maintaining key operational characteristics such as data integrity, consistency, and recoverability. To address these demands, various data protection and recovery mechanisms have been developed. Among these, snapshot storage systems have emerged as a widely implemented solution for improving data manageability in both enterprise and cloud-based infrastructures.

Generally, a snapshot storage system refers to a system or mechanism configured to capture and preserve the state of a data storage volume, file system, or other data structure at a designated point in time. Snapshots are commonly employed to facilitate backup, replication, and recovery operations. Rather than duplicating all underlying data, such systems typically operate by recording metadata or change logs that enable restoration to a prior data state. As a result, snapshot storage systems offer reduced storage overhead, increased system efficiency, and the capability to rapidly recover from incidents such as data corruption, unintentional deletions, or system-level failures.

Snapshot functionality may be implemented across various storage paradigms, including block-level, file-level, and virtualized storage systems. In block-level implementations, snapshots often utilize copy-on-write (COW) or redirect-on-write (ROW) techniques in which original data blocks are preserved, and subsequent modifications are written to new locations. File-level snapshot systems, by contrast, may leverage metadata versioning, reference counting, or journaling mechanisms to maintain access to multiple file states over time.

Snapshots may further be classified as crash-consistent or application-consistent. Crash-consistent snapshots capture the contents of storage at a given instant, without regard to in-flight application operations, whereas application-consistent snapshots typically involve coordination with application layers (e.g., through write quiescence or flushing mechanisms) to ensure the captured data can be restored in a valid and recoverable state. In modern cloud computing and virtualization platforms, snapshot capabilities are often tightly integrated with orchestration and automation frameworks, enabling dynamic, system-wide backup and restore operations across distributed computing nodes.

The Exascale file system, available from Oracle as part of the Exadata Exascale offering, is a file system designed for high-performance data storage. Exadata Exascale is part of the Oracle Cloud Infrastructure (OCI). OCI is a cloud computing platform that provides various services for building, testing, deploying, and managing applications and services. OCI is designed to offer high performance, flexibility, and scalability for different types of workloads including databases, artificial intelligence (AI), and analytics.

The Exascale file system is a sparse-aware file system that is integrated with Oracle Database. Exadata Exascale includes features, such as intelligent storage and smart scan technology, which optimize database queries and data replication for high availability. The Exascale file system manages data as Exascale volumes, and provides features, such as snapshots and clones of data, which can be used by the Enterprise Data Vault (EDV) component of the Exascale stack for accessing and utilizing the Exascale features. Exascale provides remote direct memory access (RDMA) capable storage that distributes the database across a plurality of server computing devices, such as in a cloud architecture, and implements data-aware intelligent artificial intelligence (AI) Smart Scan to make thousands of central processing unit (CPU) cores available to speed up database queries.

A sparse-aware file system is a type of file system that efficiently manages files with large regions of zeroed-out data (holes) by storing metadata about those regions instead of allocating space for them on disk or other storage. The term “sparse-aware” refers to the ability to efficiently handle and process data where a large portion of the values are zero or missing. Sparse-aware algorithms, file systems, and data structures are designed to take advantage of this sparsity in reducing memory usage and computation time compared to non-sparse aware alternatives that treat all data points as equally important. In the case of a sparse-aware file system, the metadata keeps track of the location and size of the zero blocks. This saves space, as space is only allocated to actual data, not empty blocks, and improves write performance (since no data is written for zeroed-out regions), especially for large files with minimal actual data, i.e., sparse files. A sparse file is a file that contains large blocks of zero bytes.

### BRIEF DESCRIPTION OF THE DRAWINGS

In the drawings:

FIG. 1A is an example diagram of a two-level sparsity indexing structure in accordance with one illustrative embodiment;

FIG. 1B is an example of a snapshot tree data structure in accordance with one illustrative embodiment;

FIG. 2 is an example diagram illustrating an example of OCI volume backup objects in accordance with one illustrative embodiment;

FIG. 3 is an example diagram of a multipart upload of data objects in accordance with one illustrative embodiment;

FIG. 4 is an example diagram illustrating a batch IO request payload in accordance with one illustrative embodiment;

FIG. 5 is an example diagram illustrating a batch IO reply payload in accordance with one illustrative embodiment;

FIG. 6 is an example diagram illustrating an operation for processing batches via a buffer architecture in accordance with one illustrative embodiment;

FIG. 7 is a flowchart outlining an example operation for performing a backup of a snapshot optimized sparse-aware file system in accordance with one illustrative embodiment;

FIG. 8 is an example diagram of a hardware configuration in which aspects of the illustrative embodiments may be implemented; and

FIG. 9 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Before discussing the illustrative embodiments in greater detail, it should be appreciated that the present description will make reference to example illustrative embodiments in which the Exadata Exascale (or simply “Exascale”) file system and Oracle Cloud Infrastructure (OCI) are utilized, as well as particular application programming interfaces (APIs) and input/output controls. However, it should be appreciated that the mechanisms of the illustrative embodiments are not limited to such and may be applied to other sparse-aware file systems and computing platforms without departing from the spirit and scope of the present invention. To the contrary, the illustrative embodiments described herein are for illustration purposes only and are not intended to limit the claimed invention to any one specific embodiment.

Snapshots that maintain incremental change information, i.e., only store data for the changed portions of a file, are sparse files. Again, a sparse file is one that includes one or more regions, or “holes”, that are logically present but do not contain any explicitly written data. These holes typically represent blocks of zero-value data that need not be stored on physical media. Instead, the sparse-aware file system maintains metadata indicating the presence and size of these unallocated regions, while omitting corresponding storage allocation. Sparse-aware file systems are designed to avoid allocating physical disk blocks for zero-filled regions, thereby improving space utilization and reducing unnecessary disk input/output operations.

In a snapshot optimized file system, such as Exascale, by default, files are all sparse, meaning that space is allocated only for file locations which are truly materialized, i.e., have actual data. The term “materialize” refers to a client having written to the logical location, i.e., an address range in a logical address space of a file, where the first write to that logical location “materializes” the logical location. A logical location is unmaterialized if it has not yet been written to. If a logical location never has any changes, it is “unmaterialized”. Once a logical location is “materialized,” it cannot be unmaterialized. Thus, if a region has just been allocated, or even if it has only been initialized by the application, no storage space has been allocated, as there is no materialized data. Only a true overwrite will cause the storage space to be materialized and to be committed. This allows storage to be thinly provisioned, i.e., storage is only allocated for data that is actually materialized and is not allocated for unmaterialized data locations.

Thus, in a snapshot optimized file system, the snapshots are sparse since writes are generally performed only to a relatively smaller subset of the data locations of the files, and the remainder of the locations are unmodified, i.e., unmaterialized for that snapshot. Assuming a single file for illustration purposes, in a snapshot optimized file system, the first snapshot comprises the entirety of a file, since there is no prior state for the file. Thereafter, each subsequent snapshot contains the data for only the materialized portion of the file since the last snapshot. Thus, for example, if a file is a 64 kb file, but only 8 kb of the file are actually written to since the last snapshot, then the current snapshot will only have the data for the 8kb range, while the remainder of the data for logical locations in the file are sparsely represented. In this way, a dependency tree of snapshots is generated where the actual data for the file may be represented in different ones of the snapshots based on when writes are performed to the file. An initial snapshot will be a full copy of the file, with each subsequent snapshot storing only the changes to the file made since a previous snapshot. Only the leaf nodes of this dependency tree of snapshots are writeable, with the snapshots becoming read only when the next snapshot is generated. When a restore of the file needs to be performed, this dependency tree is walked from leaf node to root to restore the file, with the current state of the file being created from the portions specified in each of the snapshots, and with the data for a same logical location in a lower snapshot node of the dependency tree (later in time) overwriting data of any higher snapshot node in the dependency tree (earlier in time).

Such sparsity and thin provisioning of the storage raises unique challenges when building a backup utility. The backups created should be aware of the sparse nature of the files, otherwise backing up the files will be very wasteful due to the need to store data for even the sparse regions of the files in the snapshots. The sparseness of the files also means that materialized regions can be scattered across the file system's logical storage space and, if the backup service is trying to capture all materialized regions, it would have to check the entire file system's logical storage space, which can be sparsely materialized. That is, when the file is to be restored, the backup service calls the storage system requesting the data for the file, polling specific portions of the logical storage space of the file system, since it is not known a priori where the data for the file is actually located in the file system's logical storage space. Hence, to ensure that all materialized data for the file has been found in the file system's logical storage space, every portion of the logical storage space needs to be systematically checked. This results in a large number of communications between the backup service and the storage system, many of which are just empty polls, i.e., the file data is not present in the polled region of the logical storage space.

Moreover, in the case of a backup service that is sparse-aware, the backup service needs to save the same sparseness information, e.g., location and size of zeroed out regions, deleted regions, initialized/re-initialized regions. The backup service should maintain this sparseness information in a compact, space efficient manner since, depending on the storage service used, the storage characteristics on which the backup service runs do not necessarily, and most likely are not, sparseness optimized. For example, a backup service could be using a cheaper, durability focused object store where access patterns and allocation requirements are more centered around never updating contiguous objects. If such a storage service does not support sparse objects, then much of these objects will be sparse and will not be updated, meaning much of the storage will be wasted. Hence, to avoid such wasted storage situations, it would be beneficial for the backup objects to be configured to store backup data, including sparseness information, in a compact or densely packed object for storage in the non-sparse-aware storage service, i.e., to provide a dense representation of a sparse file.

It is recognized that snapshot optimized file systems provide opportunities for efficient incremental backups, since incremental backups can be expressed as a difference (or “diff”') between two snapshots of a file, with each snapshot's creation time representing a frozen point of time at which the backup was taken, i.e., each snapshot represents the changes that were made to the file since a last point in time and store those changes as of the time the current snapshot is taken. This means that using snapshots for backups provides a concrete instance of files “frozen in time” at the time the backup was created. Since snapshots are already a sparse representation of the change from the parent snapshot until the time of creation of the present (child) snapshot, a difference (or “diff”) between two snapshots is a sparse logical space that the backup service now has to deal with, including the issues discussed previously. Thus, the ability to represent the file system's sparse logical space, in a contiguous and space efficient manner, i.e., a densely packed backup object, while making sure that obtaining the sparse data from storage is also network efficient, is an important capability.

### Overview of Sparse-Aware Backup Service for Snapshot Optimized File Systems

To address the challenges associated with creating backups for a snapshot optimized sparse-aware file system, the illustrative embodiments provide a sparse-aware backup service and corresponding data structures for representing, in a densely packed manner, a sparse portion of data, e.g., a file or set of files in a snapshot optimized sparse aware file system. With the mechanisms of the illustrative embodiments, snapshots are selected as backup points. Whenever a backup needs to be created, the file system is utilized to take a snapshot of the current state of the file. This ensures that all characteristics associated with a snapshot are also the characteristics of the backup point as well, even if only for the instant at which the snapshot is created. In an Exascale file system, as an example, the snapshot creation is coordinated with the application, and results in a consistent point that the application can start from. Thus, the characteristics of the snapshot are the characteristics that the backup will also have.

If this is the first time a backup is being created, a full highly sparse aware backup is created, i.e., the backup will be the entire file which is sparse-aware. If it is an incremental backup, the backup fragment is used to track materialized regions, or initialized, re-initialized, or trimmed regions that were modified between the two snapshots (previous and current) of the file. The sparse portion of the snapshot being backed up is represented in the backup object in a compact manner, using one or more logical offsets, as described in greater detail hereafter. With regard to the concepts of initialized, re-initialized, or trimmed regions, this refers to portions of a file that may have been deleted or set to an initialized value. In some illustrative embodiments, as described hereafter, specialized metadata is utilized in the backup objects to flag such regions or portions of the file.

With Exascale as an example, all files on Exascale are highly sparse aware, so it is important to ensure that the backup utility solution preserves the sparseness accurately. A file is considered highly sparse aware if it satisfies the following criteria:
1. Only materialized regions of a file are allocated logical storage space (true writes).
2. File initialization from the application is handled such that it does not cause any storage space allocation, since the initialization format does not really represent any real data and thus, real storage space allocation to track initialization is wasteful.
3. If a file region is trimmed, all space materialized in the trimmed region should be dematerialized since trimmed storage space is not space that the file cares about, i.e., it is storage space that stored data, which has now been deleted.

To find a difference between two snapshots of a file, Exascale utilizes the information about how data is allocated and tracked internally to build a description of the change between the two snapshots. Since for backup, one wants to only obtain the data that is materialized in both snapshots, and the sparseness of the file is not detectable until the content is read from the file system, one first needs a network efficient mechanism to get only the data of interest. Since the procedure to obtain data from the file system is identical for both full and incremental backups, with the difference between the two being in how much data on the file's snapshot is being requested, it is informative to first look at how a full backup obtains this data.

With a full backup, the target file's snapshot is opened for read by the backup service. Now for the entire file's logical space, individual extent sized requests are created. This is done because a file is a collection of extents, i.e., a contiguous area of storage reserved for a file in a file system, and a single extent is allowed to live on exactly one disk, although the extents of the file may be spread across multiple disks in a distributed manner. In the case of Exascale, for example, an extent belongs to one storage bucket, i.e., a container used in cloud storage services to organize and store data. It should be appreciated that while the present description will reference storage of files on “disks”, the files may be stored in any suitable storage device, such as magnetic tape, solid state memory devices, or the like.

These extent sized requests are batched by disks containing all extents belonging to that particular disk. These disk level batches are further batched by storage cells (storage systems) on which those disks live, and these batches are sent over to the storage cell. The storage cell searches for the extents on their disks and returns data corresponding to the requests in the batch if they are present. The storage cell maintains a session for processing these batches of read requests and the backup service keeps posting a buffer to reap the reads of the batches, with the reply payload describing what request in the batch the reply is for. The data that is returned is sparsely packed to improve network efficiency. To further optimize the network utilization, the storage cell of the illustrative embodiments only processes the batch read requests sequentially and does not reply anything if the region is sparse, i.e., all zeroes. If the reply buffer can hold multiple sparsely packed reads, the reply will contain multiple elements for which there is some data. This allows the illustrative embodiments to save on the number of network messages to reap the batched read request. When the entire batch is processed, the reply contains a special indicator so that the backup service knows that the batch processing is complete.

If the illustrative embodiments are performing incremental backups, everything is the same except that the individual read requests have information indicating that a differential read between two specified snapshots is requested. The sparse packing of the read also contains information to represent regions of the file that are changed, such that metadata tracks the sparseness of the file in the range, i.e., there is no data, but the region has been made sparse. This is important information needed for incremental backups.

During restore of one or more files, from the storage system's perspective, this same batched read process is run in reverse, effectively performing a batched sparse write processing of the target file being restored, and effectively recreating the original highly sparse aware file as it currently exists, i.e., after execution of the writes to the file captured in the sequence of snapshots. If the restore target does not support the same sparse awareness, the restore is capable of materializing these regions to ensure the correct logical reproduction of the original data, e.g., generating the full file with the sparse data represented in a non-compact manner, e.g., the zeroes being present in the data of the file.

### Backup Object Representation of Snapshot

In view of the above understanding of how backup points are picked and how data is obtained for a backup, as well as restored efficiently, the description now turns to how the backup data is structured and stored. First the illustrative embodiments identify what type of backup data there is. In one or more illustrative embodiments, backup data is considered to be of two primary types: 1) full backup data which is self-sufficient in describing the entire file; and 2) incremental backup data which has a parent full incremental backup it is associated with, which describes how something is modified compared to it. The backup of a file is divided into multiple backup fragments which can be of a fixed or dynamic logical size depending on the characteristics of the storage solution backup being utilized. Each backup fragment has a strict physical maximum size, e.g., 64 MB in some example illustrative embodiments. This is done to ensure access related upper bounds of performance. At a file level, the illustrative embodiments have a head fragment that describes all relevant metadata associated with the file, such as the file's type, owner information, application specific metadata that is needed to generate application specific initialization patterns, and an encryption key identifying information for the backed-up data.

Every backup fragment has two parts to it: fragment metadata and fragment data. Fragment metadata contains information describing the logical range that the fragment is describing, e.g., 0 to 64 MB. The backup service mechanisms of the illustrative embodiments track sparseness at the smallest possible allocation granularity of the particular file system. For example, in some illustrative embodiments, the smallest possible allocation for the Exascale filesystem is 8 kb and thus, these illustrative embodiments would need to track sparseness at that granularity. However, since sparseness is expected to be present, to save metadata space, the illustrative embodiments use a two level sparseness tracking scheme that employs a first logical offset index (L1) specifying the particular backup data chunk having the backup fragment, and a second logical offset index (L2) representing an offset of the materialized data of the backup fragment in the larger chunk. One can think of L1 being a coarse granularity metadata that checks sparseness in large logical ranges and when something is indeed materialized, L2 is utilized to drill down at a finer granularity to determine exactly what is materialized. For example, if one is taking an incremental backup for the last hour of work on a file, most of the content between the snapshots has no modification. Thus, if one were to use only L23 s level of fine granularity, there would be a large amount of metadata to represent a “no change” state. By using the coarse granularity of L1, the “no change” state portions of the file consume significantly less metadata, while the L2 provides the ability to perform fine grained processing when materialized regions of interest are encountered.

It should be appreciated that the “backup data chunk” mentioned above with regard to the L1 and L2 are logical pieces of a file that is being backed up, while the fragment is the physical object that will be stored. For example, if there is a 128 GB file, and it is divided into 4 GB logical backup data chunks, for each of these 4 GB logical backup data chunks, a backup fragment may be created. In other words, the backup data chunk is the logical file piece being backed up whereas the fragment is the physical representation of the backup which contains the backup's metadata and data, where the metadata comprises the L1 and L2 metadata as well as any additional flags as described herein.

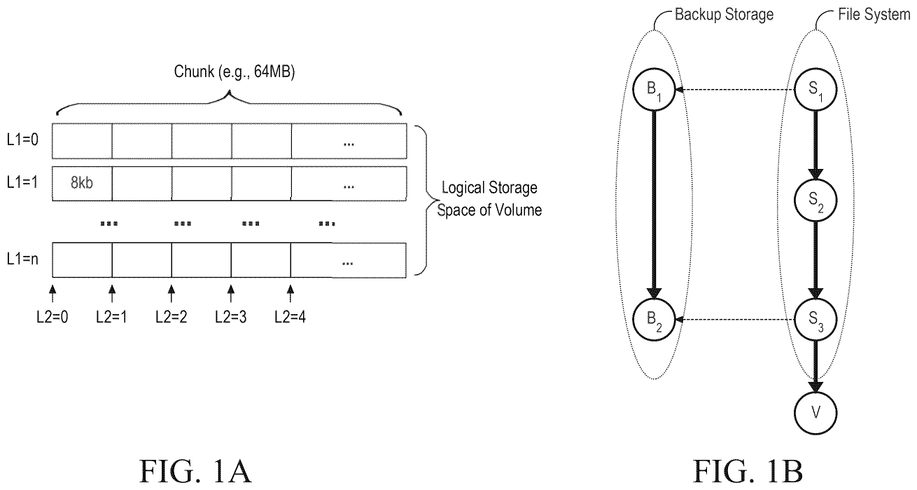

FIG. 1A is an example diagram of a two-level sparsity indexing structure in accordance with one illustrative embodiment. As shown in FIG. 1, the illustrative embodiments first track, in backup objects, whether anything is materialized in bigger chunks, represented by an L1 index value, and if the region is not sparse, then inside this bigger chunk (specified by the L1 index value), the illustrative embodiments specify materialization data (and thereby the sparseness) at a finer granularity, represented by one or more L2 index values. For example, in some illustrative embodiments, as illustrated in the example of FIGS. 1, 64 MB is the size for the bigger chunk and 8 KB is the finer granularity. Hence a storage space may be split into a plurality of 64 MB chunks, with each chunk split into 8000 8 KB blocks. Each of these 8000 blocks is indexed with a corresponding L2 index value. Each 64 MB chunk is similarly indexed with a corresponding L1 index value. The combination of a L1 and L2 index value uniquely identifies the block within the storage space.

If there is nothing materialized in a 64MB range, the illustrative embodiments do not have to track anything in that range in the backup object, i.e., there is no L1 index value or corresponding L2 index value(s) for tracking data and sparseness in that chunk. However, if there is materialized data corresponding to the chunk, then the L1 index value of that chunk is identified in the backup object and one or more corresponding L2 index value(s) may be specified to identify where materialized data may be located and where sparseness is present. For example, if a range of 16 to 24 kb in a 64 MB chunk were materialized in a snapshot, then an L1 index value for that 64 MB chunk would be specified, along with an L2 index value specifying the 16 to 24 kb range, followed by the materialized data. Hence, for large chunks of data where no data was materialized, no data needs to be stored in the backup object, however for chunks where data was materialized, this data may be represented by just an L1 index value and one or more L2 index values, depending on whether the written data is contiguous or not. For contiguous portions of the chunk that were written, a single L2 index value can be used to track the start of where the materialized data is written, followed by a counter value of how many smaller finer granularity portions are represented by the subsequent materialized data in the backup object. This significantly reduces the size of the backup object data needed to track the materialized data of snapshot files in backup objects and allows for compact and dense representations of these backups in backup objects.

This improves efficiency, especially for incremental backups where sparseness is even more prevalent. That is, it has been recognized that in snapshot optimized file systems, between snapshots, much of the data in the files of the file systems are not written to, i.e., materialized, but remain the same as in the previous snapshot or original file. However, when there is a write to a file, the write tends to not write the entire file and tends to be a contiguous portion of the file. Hence, by representing such writes in a compact manner as noted above, the size of the backup objects is considerably reduced without losing sparseness information or the ability to restore the file to its last known state.

Since the storage system also provides information about modified logical regions of the file, which are tracked with metadata and have no data associated with them, the fine granularity metadata indicates these modifications such that the illustrative embodiments know there is no data for these logical regions and can calculate it efficiently. Every bigger chunk contains the start data offset, such that it describes where the illustrative embodiments can find the relevant data offset in a quick manner. That is, the storage is broken down into fixed size chunks, e.g., 64 MB, with each 64 MB chunk being associated with a corresponding L1 index value in a sequential manner, e.g., 0 to 64 BM is L1=0, 65 to 192 MB is L1=1, 193 to 256 MB is L1=2, 257 to 320 MB is L 1=3, etc. Each of these chunks has a corresponding start data offset. Each of these chunks further has offsets specified within the chunk as indexed by the L2 index values. The L2 index values specify the start of a block of data within the chunk that is materialized, with L2 index values being assigned sequentially based on the smallest possible allocation of storage, e.g., 8KB in the above example. Hence, within a 64 MB chunk, each 8 KB range has a corresponding L2 index value sequentially assigned, e.g., where ethe first 8 KB range is given the L2 index value of 0 or 1, depending on whether the index system utilized is 0-based or not. Hence, by specifying an L1 index value and a L2 index value, a particular location within the data storage may be identified, e.g., in a 0-based index system, L1=1 and L2=1 indicates that the corresponding data is located in the range 9 KB-16 KB of the chunk corresponding to 65 to 192 MB.

In some illustrative embodiments, where the materialized data in a snapshot file spans contiguous portions of the logical storage space, these portions can be represented in the metadata of a backup object using a corresponding L2 to specify the start of a region of the materialized data, followed by a counter specifying the number of contiguous regions to which the materialized data is written. Thus, for example, an L2=1 may be specified, followed by a counter value of 2, meaning that the materialized data starts at the offset corresponding to L2=1 in the corresponding data chunk (specified by an L1 value), and the counter value specifying that the materialized data spans L2=1 and the next consecutive L2, i.e., L2=2. This allows a single L1 value and a single counter value to be used to specify multiple minimum allocation size portions of the logical storage space. This is especially useful when the counter is greater than 2, meaning that fewer values are needed to represent larger size portions of data chunks that were materialized, e.g., rather than having to specify 3 separate L2 values to represent 3 blocks written to by the materialized data, a single L2 value and a single counter value is utilized.

In some illustrative embodiments, trimmed, reinitialized, or initialized data is represented in a similar manner, however specialized metadata flags may be provided to indicate that the corresponding “materialized” data is zeros or “don't care” values. That is, trimmed data is data that has been deleted from a file and thus, the values of the data in this range are irrelevant. Hence, these portions of the file can be similarly represented in the metadata using L1 and L2 values, but with corresponding flags to specify that while this data is considered “materialized”, the data does not need to be represented as a materialized data portion in the backup object, thereby further reducing the size of the backup object and providing a more compact representation of the backup corresponding to the snapshot file.

All the data that corresponds to the logical address, e.g., L1 and L2, and represented by the metadata, is placed contiguously after these logical addresses, counters, and flags. That is, after specifying the L1s and L2s for a snapshot file in the backup object, where the L1s and L2s are also referred to as the backup fragment metadata, the backup object stores the materialized data corresponding to the specified L1s and L2s. Additional offsets within the backup object may be specified to correlate the particular set of L1s and L2s represented in the metadata, to the corresponding materialized data in the backup object. In this way, the fragment metadata (L1s and L2s) effectively describe the data offset that materialized region(s) are representing. If the backup storage solution is an object store, each fragment is an individual object and the head fragment is also a separate object describing information for the individual fragments. If the storage solution is a regular file system instead, the head fragment can be a separate file, describing information about the fragments, with the fragments being either combined in a single file consecutively or represented as individual files.

Thus, the illustrative embodiments provide advantages and benefits over existing backup systems in that the illustrative embodiments provide a highly sparse aware backup mechanism with support for incremental backups. The illustrative embodiments provide the ability for trimmed file regions to be backed up using just metadata for space efficiency, i.e., the “don't care” data of the trimmed region is not present in the backup object. The illustrative embodiments provide an efficient network utilization mechanism to obtain/retore only materialized data for both incremental and full backup scenarios, i.e., when searching the backup storage for data for a file, responses are only received when the region being looked up actually contains the data of the file, and this may be performed in a batch request manner. The illustrative embodiments provide backup metadata structured such that various storage types can be efficiently utilized, e.g., sparse-aware and non-sparse aware storage types. For example, object stores, sparse aware file systems, and generic file systems can all be used efficiently.

The illustrative embodiments provide the ability to use both dynamically sized and fixed max sized backup fragments depending on the backup storage solution used, to optimize for efficient access and retrieval of backup fragments. Consistent backups are made possible by utilizing file system snapshots to provide the same consistency characteristics as are provided by the file system that takes the snapshot. With the backup mechanisms of the illustrative embodiments, the same characteristics are applicable to incremental backups as to the original backup.

Moreover, the illustrative embodiments provide sparse packing which is aware of sparse regions that are only tracked by metadata. This is relevant information for efficient incremental backup reads.

In other words, the illustrative embodiments provide, among other advantages and benefits, the following advantages:
1. Space efficient, sparse-aware backups and incremental sparse-aware backups;
2. Fixed max size objects to represent all backed-up data, i.e. an internally compact and contiguous backup object representing a sparse logical file of the highly sparse file system, which works well with storage solutions such as object stores for storing backup data (a non-object store type solution can also be used);
3. Network optimized mechanisms to read only the materialized region in a batched manner both during full backups and incremental backups;
4. Using snapshots provided by the file system, e.g., an Exascale file system, provides a consistent instance of time for which the backup is created. Using this mechanism, every incremental backup also provides backups which always stay consistent from client application's perspective, since every snapshot is created to be consistent with coordination with the owner client application if needed;
5. A sparse aware restore from backup which ensures the sparseness of the file is recreated and keeps the restoration of the file also equally space and network efficient; and
6. Trimmed regions of a file, or trim generated overwrites during incremental backups, are handled specially to ensure storage efficiency.

### Example OCI Object Storage Backup Embodiment

The following example implementation, according to one or more illustrative embodiments, will assume an Oracle Cloud Infrastructure (OCI) object storage backup implementation for non-limiting illustration purposes. Modern cloud object storage offers ways to store data in a hierarchy with good availability and durability. This makes it a perfect candidate as an external destination to backup data from an Exascale cluster, which provides isolation and data availability across different clusters. The Exascale cluster is a multi-tenant architecture for Oracle Database that allows multiple virtual machine (VM) clusters to share a pool of storage resources. An Exascale volume backup is introduced for this purpose of using a cloud object store for backup purposes.

A backup can be taken of a read-only (or write-once) entity. This is such that a consistent view of the entity (volume, file, etc.) is backed up. For volumes (a set of one or more files), this means a backup can be taken of a snapshot of the volume. Objects are write-once by construction and thus, can be backed up in a straight-forward manner. Files, and collections of files, need to be in a read-only state before a backup can be initiated. Volume backups are made out of volume snapshots.

For a volume, when a snapshot is taken, the snapshot becomes a node in a snapshot tree data structure of the volume, which as an example is considered a single file for ease of explanation, but may be more than one file in actual practice. The snapshot tree data structure represents all snapshots and clones (writeable copies) of the file that have been made up until the current time, in a parent-child relationship hierarchy. Further writes to the file employ the redirect-on-write methodology such that only blocks changed with respect to the previous snapshot are allocated. In this way, snapshots, clones, and the current working version of the file exist in an incrementally changing fashion such that any entity only stores the difference, or “diff”, from the previous snapshot, thereby saving allocated storage space.

All backups of volumes in an Exascale cluster reside in one bucket in the object store, named <cluster GUID>. <bucket name root>. For example, for cluster GUID, ‘1000fbbd-c54f773a-3ee595bf-f2a0821’, and bucket name root, ‘bstbkps’, the bucket name is ‘1000fbbd-c54f773a-3ee595bf-f2a0821.bstbkps’. The bucket name root is specified in the underscore param, ‘_exc_bsw_bkp_bucket_name_root’. Each volume that is backed up has one root object in this bucket. The object ID is the same as the volume ID (e.g., 1) corresponding to the volume. This way, all volumes that have been backed up can be easily listed by listing all objects in this bucket under “files/”, e.g., 1000fbbd-c54f773a-3ee595bf-f2a0821.bstbkps/files/. This object (root object) will house the backup tree for this volume and other metadata.

For volume backups in V1, all backups are full backups, meaning the full data copy of the snapshot node is backed up to the OCI object storage. Similarly, the illustrative embodiments perform incremental backups, in which case, the Exascale file system service will be able to read and backup the modified blocks since the last backup.

For example, with reference now to FIG. 1B, assume for a volume V, the snapshot tree data structure looks like that shown on the right-hand side of FIG. 1B. As shown in FIG. 1B, initially, snapshot S1 represents the original volume V in a writeable manner. Thereafter, at various times, additional snapshots S2, S3, and V are generated with V being the current writeable version of the volume, while prior snapshots in the hierarchy are read-only and represent a point-in-time state of the original volume. That is, snapshot S1 represents the original state of the volume, snapshot S2 represents any changes from this original state that occurred up to the time when snapshot S2 was generated, S3 represents the changes that occurred since the time S2 was generated, and V represents the changes to the volume that occurred since the time S3 was generated.

If one wants to take backups of a snapshot of this volume V, it can be either a full backup, e.g., B1, that contains all of the data in S1, or an incremental backup, e.g., B2, that can be incremental in V and which only contains modified data between snapshots, e.g., snapshots S3 and S1 in this example.

As can be seen from FIG. 1B, the incremental backups need not correspond one-to-one to each snapshot of the volume that is generated and stored. That is, a single backup, e.g., B2, may represent the changes that occurred, and which are represented in multiple snapshots S2 and S3, as the incremental backup is backing up all changes that occurred since a last incremental or full backup, e.g., B2 is backing up all changes since B1 was generated. Thus, the backup tree data structure (left hand side of FIG. 1B) may have fewer incremental backups than the number of snapshots in the snapshot tree data structure, although in some illustrative embodiments, backups may also be generated for every snapshot if desired. For example, a file system may be configured to generate a snapshot every hour, whereas the backup utility may be configured to generate a backup every 2 hours, or every day, for example. However, as noted above, when a backup is to be generated, the file system will first generate a snapshot that serves as the basis of that backup to ensure that all application state is properly represented in the backup object.

The backup objects B1, B2, etc., contain the backup object metadata specifying the logical indices L1 and L2 for the materialized portions of the backup object, i.e., the portions of the file(s) that were changed since the last backup object was created, which in turn specifies the sparseness information, i.e., the unmaterialized portions, which are the portions that do not fall within the changed portions. The L2 index values may have associated counter values specifying how many contiguous blocks of data correspond to that L2 index value. Moreover, in cases where there is data that has been trimmed, reinitialized, or initialized, these portions of data may be represented only in the metadata with corresponding L1, L2 values and a flag indicating the data in the portions specified by the L1 and L2 values being “don't care” data. For the materialized portions of data, i.e., the changed data in the snapshot(s) serving as the basis for the backup object, this data may be retrieved from the storage system for inclusion in the backup objects, such as in portions following the backup object metadata in the backup object. As the backup object may store data for multiple materialized portions, which may be non-contiguous, pointers to locations within the database object where the corresponding data resides may be utilized to identify which data corresponds to the (L1, L2, counter, flag) sets in the backup object metadata.

### Exascale APIs to Manage Volume Backups

In some illustrative embodiments, one can either use RESTful application programming interfaces (APIs) to manage the lifecycle of a backup object, or use a command line tool, such as ESCLI command line commands, to issue control operations. Full documentation for RESTful APIs and ESCLI commands may be found in the Exascale documentation and ESCLI help.

A user can create a volume backup by giving the snapshot id of the volume snapshot the user wants to backup, once successful, the reply will contain the backup id of the created backup, as follows:
RESTful api: POST/exascaleapi/v1/volumeBackups
escli: mkvolumebackup—snapid <snapshot id>

A user can delete a volume backup by giving the backup id of the backup object as follows:
RESTful api: DELETE/exascaleapi/v1/volumeBackups
escli: rmvolumebackup <backup id>A user can restore a volume backup to a refresh volume by giving the backup id of the volume backup that the user wants to restore, and once successful, the reply will contain volume id of the volume being restored to:
RESTFful api: POST/exascaleapi/v1/volumes
escli: mkvolume—vault <vault name>—attributes volumeBackup=<backup id>

### OCI Object Storage APIS

The illustrative embodiments can make use of OCI object storage as a backing store for volume backup data. Those of ordinary skill in the art are aware of how object storage works and how to build OCI object storage API references and thus, a more detailed explanation is not provided herein. Documents describing such object storage and OCI object storage API references are available from Oracle International Corporation through their websites.

In some illustrative embodiments, each Exascale cluster is assigned a dedicated object storage bucket, where the bucket is not directly accessible to clients. Lifecycles and access policies of the objects inside the bucket are managed directly by Exascale volume services.

For volume backups, in some illustrative embodiments, the illustrative embodiments make use of the multi-part upload APIs to upload volume backup data in a parallel fashion. For downloading data, in some illustrative embodiments, GET APIs are used with optional byte range parameter to retrieve data of offset within (BEGIN, END) from an object.

### OCI Volume Backup Objects

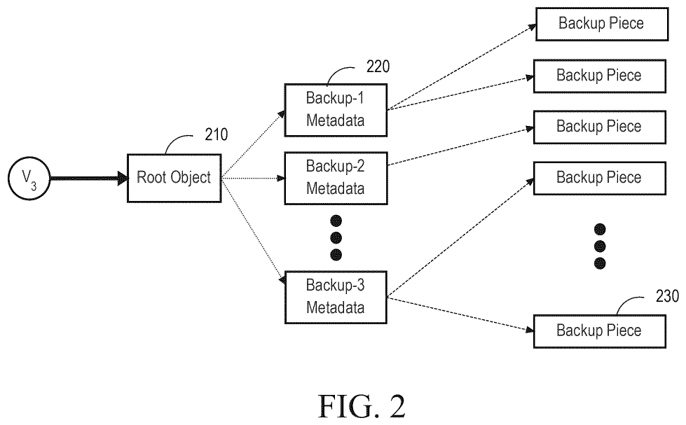

Each object in OCI is like a distinct file with separate lifecycle management. Therefore, to support volume backup, the illustrative embodiments have different types of storage objects in OCI to serve volume backup metadata and actual data. As shown in FIG. 2, these storage objects include Volume Backup root objects 210, Volume Backup metadata objects 220, and Volume Backup data objects 230, for example. Volume Backup root objects 210 are objects with name <bucket name>/files/<volume no.>, and which contain metadata information about the backup tree of the associated volume. Reading and parsing this object will give the Exascale file system first level information about all backups associated with the volume.

Volume Backup metadata objects 220 are objects with name <bucket name>/backups/<volume no.>/<backup no.>, and which contain metadata information about a specific backup of the associated volume. Reading and parsing this object will give the Exascale Backup Manager detailed information about the individual volume backup and first level (metadata information) of volume backup data objects. The Exascale file system stores the actual data, whereas the Exascale Backup Manager interprets the backup, and may be provided as a separate standalone entity from the Exascale file system.

Volume backup data objects 230, also sometimes referred to as backup piece objects, are objects with name <bucketname>/backup_pieces/<volume no.>/<backup piece no.>, and which contain actual data and index information, e.g., L1 and L2, counter, and flag information, of a volume backup.

### Using Multipart Upload of Data Objects

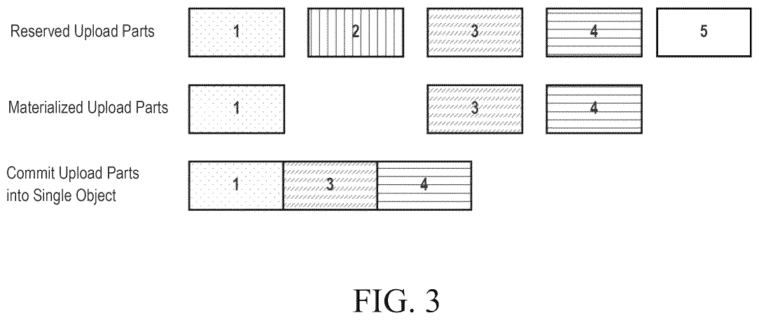

FIG. 3 is an example diagram of a multipart upload of data objects in accordance with one illustrative embodiment. The “upload” refers to taking the backup fragment (containing fragment metadata having L1, L2, etc., and the data) as an object and sending it to the storage which can be an object store or a file system, for example. For example, the upload is the storage of the files in a data store of OCI in the present example. The “parts” in FIG. 3 refers to partitions of a file. For example, if a file is a 1 TB file, a worst case scenario may be that the entire file is materialized and thus, there would be a 1 TB+physical backup object, which is too large to manage efficiently. Thus, the file may be partitioned upfront into parts (L0), e.g., 128 GB partitions. In this way, it is known that, for a worst case, how large a single backup object can be, i.e., 128 GB in this example, and that allows sizing of the backup accordingly. The “part number” refers to the particular partition of the file.

The graph in FIG. 3 illustrates how multipart upload works for a single object. When an OCI client needs to start an upload, the client can use the following REST API to reserve a number of upload parts, for example, the five upload parts 1-5 in FIG. 3 using post /n/{namespaceName}/b/{bucketName}/u. The upload of parts is materialized using each upload part number, e.g., 1, 3, and 4 in the depicted example, and put requests like the following (which can be parallelized): put/n/{namespaceName}/b/{bucketName}/u/{objectName}. The upload parts are committed into one contiguous single object using post /n/{namespaceName}/b/{bucketName}/u/{objectName}.

Thus, for example, the reserved upload parts in FIG. 3 may represent a snapshot of the original file in the volume, and thus, is a full snapshot having all of parts 1 through 5. The materialized upload parts may represent a sparse-aware snapshot of the file, where the changes to the original file may be made to parts 1, 3, and 4, e.g., changes were made to the 64 MB chunks 1, 3, and 4, and where no writes were performed to parts 2 and 5. The part numbers referenced in FIG. 3 may correspond to L1 values, i.e., the sequential representation of the logical addresses for data chunks in the volume, as previously described above, e.g., L1=1 is a first data chunk from 0 to 64 MB.

The commit of the upload parts may be the generation of a backup object that is densely packed such that the metadata and materialized data are packed together in a smaller sized object. Thus, once the commit is done, there will be a single object inside the object bucket with contents of the uploaded parts (e.g., 1, 3, and 4) densely packed together and which is retrievable via a GetObject request, for example. For Volume Backup data objects, the volume service uses multipart upload to parallelize different upload parts for optimized throughput.

### Reading Data from Storage Cells

The backup objects stored in the storage system, or storage cells, are incremental and thus, store only the data that has changed from the last backed-up snapshot (at the granularity of 8 KB blocks, for example). The illustrative embodiments provide a mechanism to more efficiently read only the modified data specified in snapshot files from the storage system when generating an incremental backup. That is, the snapshot files only store the data that was modified since the last snapshot. Similarly, incremental backups of these snapshot files, likewise store only the incremental changes since the last backup. Thus, data that was not modified is not represented in the snapshot files/backup object, but instead is represented as metadata specifying the sparse portion of the snapshot file(s), and the corresponding portions of the backup object, e.g., if in a 64 MB chunk, only the range 0-256 kb is modified, then everything else in the 64MB chunk is not modified and is sparse with regard to this snapshot file/backup object. Thus, in order to generate a backup object based on a snapshot file, rather than having to read the entirety of the file to generate an incremental backup object for the snapshot file, it is more efficient to read only the materialized portion and store that as part of the data in the backup object. Similarly, when one needs to use the backup objects to restore the file, one must be able to traverse the backup tree (see the example in FIG. 1B), in a bottom-up manner, using reads that only read the modified portions of the file from the storage system.

One could read data from an Exascale file using the edslib read API. However, there are two artifacts of the edslib read API which make this unsuitable for the present purposes: the API can be used to read data starting from a file offset with a contiguous range of up to 1 MB, and each new read request requires a round trip from the client to the cell server (or “cellsrv”), i.e., the data storage system, and back. The cellsrv is the primary component in Oracle Exadata Storage Server software that is responsible for providing core storage services, handling database requests for disk IO, advanced SQL offload capabilities, and IO resource management, while also collecting metrics and statistics for monitoring performance and capacity.

What is needed is to read only modified data between the current snapshot that is being backed-up, and the snapshot corresponding to the last snapshot that was backed-up. The default edslib read API does not support this. However, even if one could teach edslib to only return modified data, the size of that data in each 1 MB logical address space of the file would likely be very small. This would lead to very poor utilization of the outstanding read buffer. In addition, for each 1 MB address space, one would have to issue a new request causing a round trip between the Block Store Worker (BSW) service (a service that handles requests from block store clients and performs the resulting storage server IO) and cellsrv. This would be too slow and inefficient.

For these reasons, the illustrative embodiments provide a new mechanism to get data from cells (portions of the storage system), similar to a reverse Input/Output Control (IOCTL). With this new mechanism, the BSW service first gets extent (portions of a volume or file) translations for the file (e.g., using edslib) for a default mirror. The BSW service then sends an IOCTL to each cell (storage system) for the extents that reside on it. Each extent structure also contains information detailing that this is a sparse read between two snapshot IDs (the last snapshot whose back up exists, and the current snapshot being backed up). Each cell replies with densely packed sparse data in 1 MB buffers, a flag indicating if there is more data to be returned, and a token ID identifying this batch read session. If there is more data, the BSW service reserves another 1 MB buffer and sends another IOCTL to the cell with the same token ID.

When all data for the extents specified has been returned, the cell (storage system) indicates so in its reply, thereby ending this batch read session.

It should be appreciated that the data in each 1 MB buffer can span multiple extents. This dense packing helps transfer the modified data from cells to the BSW service efficiently.

### Batch Read for Incremental Backup

In order to support fast volume backup, there is a need for an efficient way to read the differences (or “diff”) between two volume snapshots from a cell. The illustrative embodiments therefore provide a “batch read” functionality and corresponding logic and mechanisms, which allow the client to send all extent ids it wants to read in one request. The client then repeatedly “pokes” the cellsrv for the read data, e.g., by repeatedly sending batch read requests, until the cellsrv indicates that there are no more data to return.

That is, the Exascale Backup Manager sends a backup request only once to the storage. For example, the Exascale Backup Manager may send a backup request specifying “give me data for everything that changed between snapshot S1 and S2.” Then the Exascale Backup Manager keeps reaping the data. The Exascale file system keeps replying with self-descriptive content (data+metadata) back to the Exascale Backup Manager until the entire request is exhausted.

Thus, the illustrative embodiments enable the file system, e.g., Exascale file system, to efficiently read differences between two snapshots, e.g., S1 and S2 in the above example. This allows for efficiently obtaining backup data and metadata from an IO resource perspective, and also improves network efficiency. Unnecessary, i.e., not materialized, regions do not cost any IOs and network resources are not wasted by sending back a large number of “region not materialized” messages. Moreover, only the file system needs to remember which regions are materialized for incremental backups.

### High Level Design

Each batch read request (or batch read session) is associated with a unique batch IO token Id. The batch IO token Id is used to uniquely identify a batch read job. To start a batch read session, the client sends a batch read handshake request. The handshake request is a batch read request with invalid token id set in the batch IO metadata header. In the handshake request, the client also includes all the extent ids the client wants to read. In the batch read reply, in addition to the data which the client asks for, the illustrative embodiments also include the batch IO token id in the batch IO metadata header. In case there is more data pending, the client will keep sending batch read requests with this token id to reap the rest of the data until all the data are transmitted back to the client.

### Example Implementation of Batch IO Request and Replies

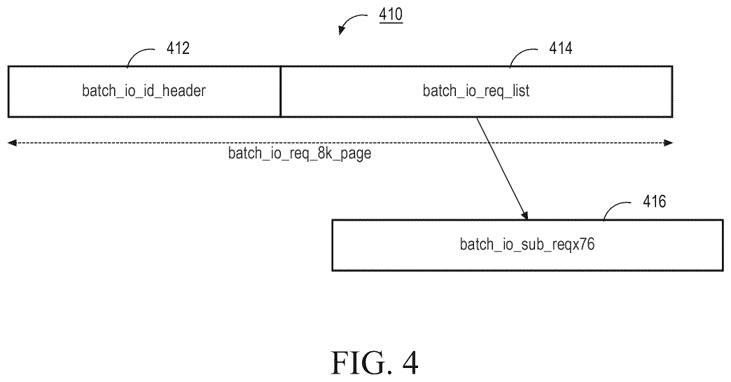

FIG. 4 is an example diagram illustrating a batch IO request payload in accordance with one illustrative embodiment. For the batch IO request, the read IOCTL opcode is IOCTL_BATCH_READ. The batch read hashtable is a hashtable structure in a virtualization management platform VMgr to keep all the ongoing batch read jobs. The batch IO token Id is used as a key for both insertion and lookup. The batch IO request payload includes multiple batch_io_req_8 k_page structures 410 (only one of which is shown in FIG. 4), if one 8 k page is not enough to hold all the extent ids to read.

As shown in FIG. 4, the structures 410 include a batch_io_id_header 412 and a batch_io_req_list 414. With regard to the header 412, the header may include a token id, a request size, a number of extents to read, an error code, a sequence number, and other metadata. The token_id is a unique identifier of the batch read job. Another usage of the token_id is to indicate to the client that there are no more reads to reap, where this notification may be performed by setting BATCH_IO_TOKEN_ID_INV in the reply. The token_id is only valid for a single batch read session and keeps incrementing. If the batch read job cannot be found given a token_id, the illustrative embodiments will return an error back to the client. The req_size is the size of the request, num_reqs is the number of extents to read, error_code is any code specifying the encountering of an error, and seq_num is present but unused and is only applicable in batch IO (write) mode.

The request list 414 may comprise sub requests 416, e.g., batch_io_sub_req, with each sub request specifying, for example, a buffer size, a buffer offset, an error code, and one or more flags. The flags may include a flag indicating that the read buffer is sparsely packed, for example.

In some illustrative embodiments, as an example, the batch IO reply payload may be of the type:
[Batch read reply header, number of request, flags, etc.]
[(LogicalAddr1 is materialized for LogicalSize1: Sparsepacking metadata1, packed/unpacked data1, errorCode1),
(LogicalAddr2 is materialized for LogicalSize2: Sparsepacking metadata2, packed/unpacked data2, errorCode2),
(LogicalAddr6 is materialized for LogicalSize6: Sparsepacking metadata6, packed/unpacked data6, errorCode6),
(LogicalAddr17 is materialized for LogicalSize17: Sparsepacking metadata17, packed/unpacked data17, errorCode17)]

As one can see from the above example, the packed reply contains multiple reads packed into one reply to reduce the network messages. If there is an error for some read request, e.g., permissions missing, read IO error, or the like, the reply includes the errorCode so that the backup manager, e.g., Exascale Backup Manager, can either resolve the situation if possible or remember that the read failed and handle the backup of that region or try another mirror if applicable.

The packed data can have a physical size different than the logical read size, e.g., consider a case where the backup manager asks to read a 1 MB portion of data but inside that 1 MB there are only 2 8 Ks that are materialized. The logical size is 1 MB, however with the mechanisms of the illustrative embodiments, the sparse metadata is utilized which describes which 8Ks are materialized, such that the physical size of the packed data is only 2×8 Ks+sparse header size.

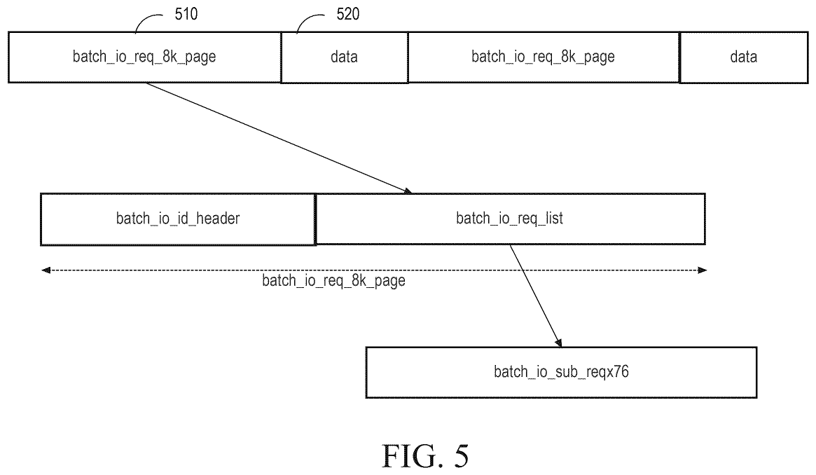

FIG. 5 is an example diagram illustrating a batch IO reply payload in accordance with one illustrative embodiment. As shown in FIG. 5, the illustrative embodiments pack multiple read requests into a single reply buffer in a batch read job. Regardless of the IO size, the batch read job creates 1 MB buffers serving as reply buffers. Before issuing a read, the mechanisms of the illustrative embodiments reserve space in the 1 MB buffer and split the request into multiple smaller ones if the IO size is too big to fit in the reply buffer. For every read request, the mechanisms of the illustrative embodiments issue a sparse read and create a file system read job to handle the read. Instead of giving a fully allocated buffer, the mechanisms of the illustrative embodiments give an empty cacheable data structure to the read job. Upon receiving the empty cacheable data structure, the read job consults fillAlloc to calculate how much space the read job really needs and calls a parent job's allocate buffer function to allocate space in the 1 MB buffer. Next, the read is officially issued to the storage system, e.g., a grid disk.

Inside the reply buffer, as shown in FIG. 5, metadata headers are packed in terms of 8 k metadata pages 510. and data 520 are packed next to the metadata pages. A read that does not return any data (i.e., buffer space needed is 0) is not included in the reply buffer to save space. Thus, once the read completes, since only materialized data is returned in the replies, an already sparsified buffer is returned, densely packed in the batch IO payload.

### Processing Batch Read Request

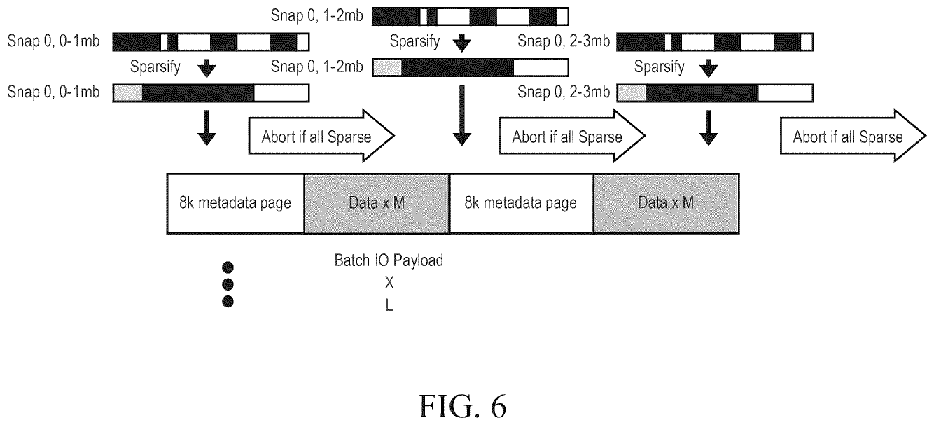

FIG. 6 is an example diagram illustrating an operation for processing batches via a buffer architecture in accordance with one illustrative embodiment. As shown in FIG. 6, a read failing with an error is still included in the reply buffer. If the read fails before buffer allocation, there will be no data buffer in the reply. If the read fails after buffer allocation, the data buffer is still prepared even if it does not contain useful data. In the example implementation, the data buffers are rounded up to the nearest 8 k multiple and are always 8 k aligned to ensure read performance.

When the mechanisms of the illustrative embodiments receive a batch read handshake request, the mechanisms create two jobs: a batch read job and a batch read reaper job. The batch read job is inserted into the batch read hashtable in the virtualization manager VMgr. The batch read job will generate the token Id and start to prepare the reads, while the batch read reaper job takes care of the network reply and sends the token Id along with read data back to the client. If more reads are pending, the client will issue more batch read requests with the token Id that was just return. The mechanisms of the illustrative embodiments look up the corresponding batch read job in the batch read hashtable and then create a batch read reaper job to send back the read data. This process is repeated until there is no more data to reap. Invalid token Ids are set in the last reply buffer to indicate that this is the end of the batch read session.

### Batch Read Reaper Job Flow

The batch read reaper job periodically pokes the batch read job to see if there is any reply available. If not, it will be queued and try again later.

The batch read job starts by generating a token Id. Next it parses the next request from the request payload. If no reply buffer has been allocated, or if the current reply buffer is nearly full, the batch read job will allocate a new 1 MB reply buffer. Then space is reserved in the reply buffer. If the read request is larger than the remaining space in the reply buffer, the read request will be split into several smaller ones. After this, the read is issued to read job and then the above steps are repeated until no more reads are pending.

There can be multiple outstanding reply buffers, waiting for reads to complete. The mechanisms of the illustrative embodiments keep track of how many reads are pending by keeping a reference counter on the reply buffer. The reference counter is bumped up when a read is issued, and is decremented when reads complete. When the reference counter drops down to 0, the reply is ready to send. In addition, the mechanisms of the illustrative embodiments assign a sequence number to each reply buffer to indicate which reply should be sent first, based on the ordering of the read requests. A reply with a larger sequence number cannot be sent back to the client if any replies with smaller sequence numbers are still pending.

### Example Operation for Performing a Backup of a Snapshot Optimized Sparse-Aware File System

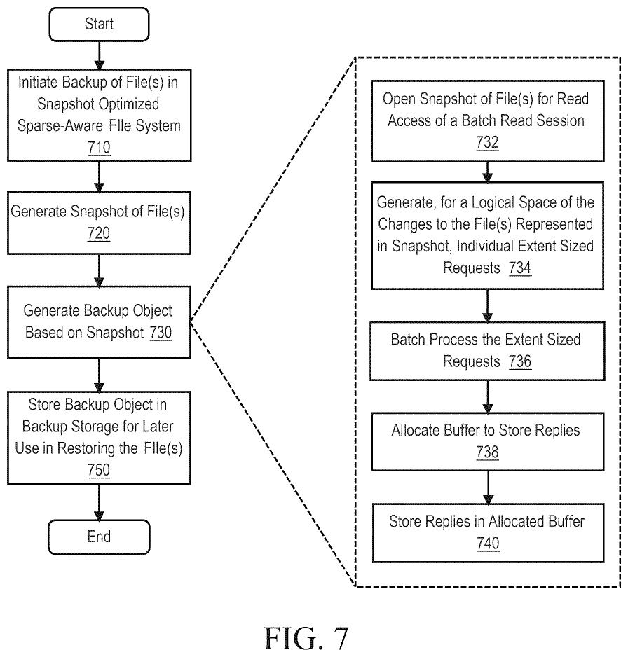

FIG. 7 is a flowchart outlining an example operation for performing a backup of a snapshot optimized sparse-aware file system in accordance with one illustrative embodiment. Details of the steps outlined in FIG. 7 have been provided previously herein above. As shown in FIG. 7, the operation starts by initiating a backup of at least one file in the snapshot optimized sparse-aware file system (step 710). A snapshot of the at least one file is generated, where the snapshot is a sparse-aware snapshot storing only changes to the at least one file since a previous snapshot of the at least one file, and sparsity information (step 720). The operation then generates a backup object based on the snapshot (step 730). The generation of the backup object may include storing the change data of the snapshot in the backup object and representing the sparsity information of the snapshot as one or more logical offsets in the backup object, for example.

In some illustrative embodiments, the generation of the backup object includes the steps of opening the snapshot of the at least one file for read access of a batch read session (step 732); generating, for a logical space of the changes to the at least one file represented in the snapshot, individual extent sized requests (step 734); batch processing the extent sized requests by a storage system (step 736); and allocating a buffer to store replies returned by the storage system based on the processing of the extent sized requests (step 738), where the data returned is sparsely packed in the buffer. The replies are then stored in the allocated buffer (step 740). Thereafter, the backup object is stored in a backup storage for later use in restoring the at least one file (step 750) and the operation terminates.

In some illustrative embodiments, the replies returned by the extent sized requests are processed in a sequential manner, where no reply is returned if a region is sparse and the sparsely packed data of the buffer constitutes the backup of the file. In some illustrative embodiments, the batch processing includes batching a set of extent sized requests, for a first set of one or more storage devices, by storage cells. In some illustrative embodiments, generating individual extent sized requests includes obtaining extent structures for the at least one file, and sending an input/output control message to each storage cell for extents that reside on the storage cell. In some illustrative embodiments, each storage cell responds to the input/output control message with densely packed sparse data, a flag indicating if there is more data to be returned, and a token identifier identifying the batch read session.

In some illustrative embodiments, each extent sized request contains information detailing that the extent sized request is a sparse read between two snapshots specified by snapshot identifiers. In such illustrative embodiments, a first snapshot in the two snapshots is a last snapshot whose backup object already exists, and a second snapshot in the two snapshots is the snapshot that is being backed up in the backup object.

In some illustrative embodiments, the extent sized requests that do not result in the return of any data are not included in the buffer. In some illustrative embodiments, a sparseness of the at least one file is tracked via a two-level sparseness tracking scheme comprising a first level tracking that determines whether data is materialized at a data chunk level, and if the data chunk is not sparse, then utilizing a second level tracking that determines where, within the data chunk, data is materialized on a smallest granularity supported by the snapshot optimized sparse-aware file system.

In one or more illustrative embodiments, the one or more logical offsets comprise a first logical offset index that specifies a chunk in a storage space, and a second logical offset index that specifies a block within the chunk specified by the first logical offset index. In some illustrative embodiments, the size of the blocks is equal to a minimum allocation size for a storage system of the at least one file. In one or more illustrative embodiments, the sparsity information of the snapshot is further represented by a counter value associated with the second logical offset index, where the counter value specifies a number of contiguous blocks that are materialized starting with a block specified by the second logical offset. In some illustrative embodiments, the sparsity information of the snapshot is further represented by a flag value indicating whether or not data corresponding to the second logical offset index is trimmed, initialized, or re-initialized data. In some illustrative embodiments, the backup object stores the change data for a plurality of snapshots corresponding to changes to the at least one file since a previous backup object was generated.

In one or more illustrative embodiments, the snapshot is one of a plurality of snapshots in a hierarchical snapshot tree data structure corresponding to the at least one file. In such illustrative embodiments, the backup object is one of a plurality of backup objects in a backup object tree data structure corresponding to the hierarchical snapshot tree data structure, and restoring a file from a backup storage comprises traversing the backup tree data structure in a bottom-up manner to read data from the backup objects of the backup object tree data structure. In such illustrative embodiments, there may be fewer backup objects in the backup object tree data structure than snapshots in the hierarchical snapshot tree data structure.

### DBMS Overview

The mechanisms of the illustrative embodiments may be implemented to improve the backup of data in database systems, which may be distributed across multiple storage systems and/or storage devices. The following is a description of a database system and its components with which such vector indexing technologies may be employed and with which the mechanisms of the illustrative embodiments may be implemented to improve upon these vector indexing technologies.

A database management system (DBMS) manages a database. A DBMS may comprise one or more database servers. A database comprises database data and a database dictionary that is stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

A database command may also be in the form of an API call. The call may include arguments that each specifies a respective parameter of the database command. The parameter may specify an operation, condition, and target that may be specified in a database statement. A parameter may specify, for example, a column, field, or attribute to project, group, aggregate, or define in a database object.

In a DOCS, a database command may be in the form of functions or object method calls that invoke CRUD (Create Read Update Delete) operations. Create, update, and delete operations are analogous to insert, update, and delete operations in DBMSs that support SQL. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, a branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains definition metadata that defines properties of the database object. For example, definition metadata in a database dictionary defining a database table may specify the attribute names and data types of the attributes, and one or more files or portions thereof that store data for the table. Definition metadata in the database dictionary defining a procedure may specify a name of the procedure, the procedure's arguments, and the return data type, and the data types of the arguments and may include source code and a compiled version thereof.

A database dictionary is referred to by a DBMS to determine how to execute database commands submitted to a DBMS. Database commands can access or execute the database objects that are defined by the dictionary. Such database objects may be referred to herein as first-class citizens of the database. A first-class citizen is associated with a database object name, which can be referenced in database commands to identify the first-class citizen to DBMS. The database object name is mapped or otherwise associated with the database object. The DBMS refers to the definition metadata of the first-class citizen to determine how to access or execute the first-class citizen.

A database object may be defined by the database dictionary, but the definition metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. java file) and the compiled version of the class (i.e.. class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data type and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

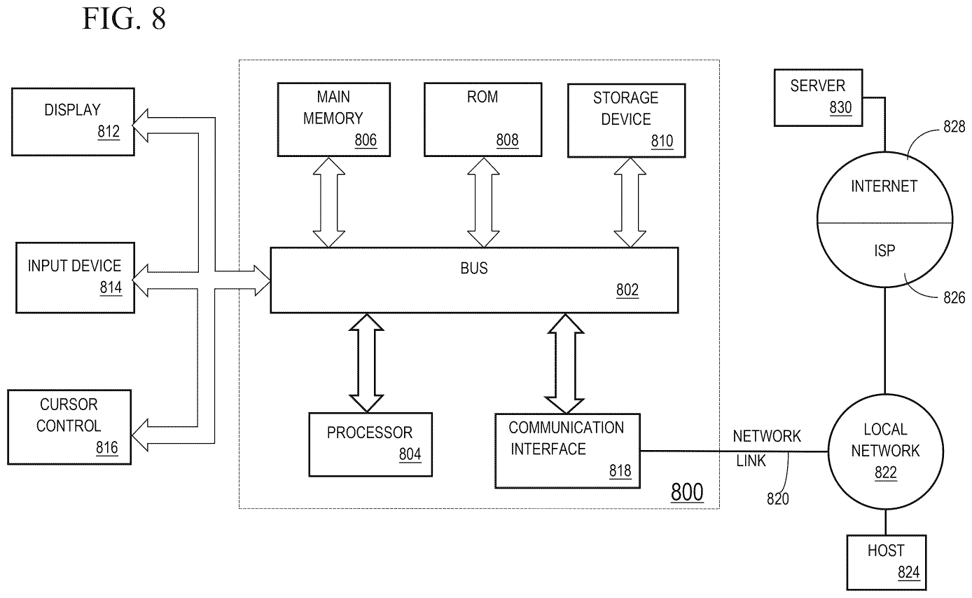

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### Software Over View

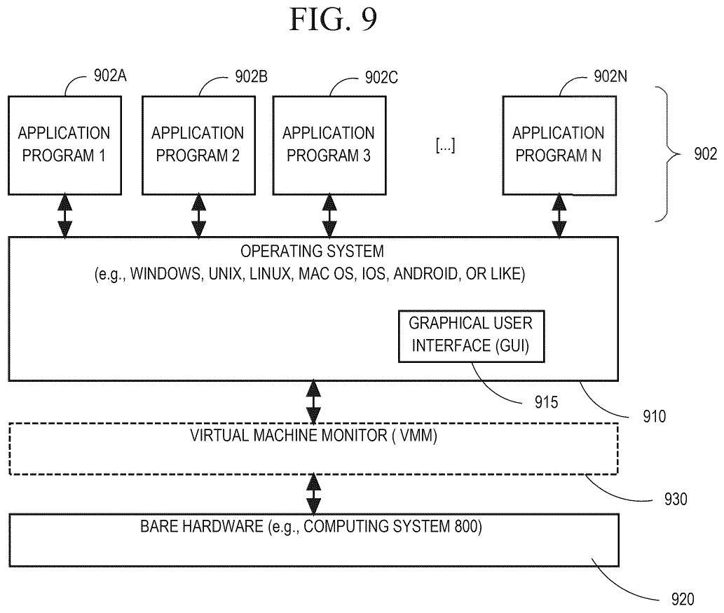

FIG. 9 is a block diagram of a basic software system 900 that may be employed for controlling the operation of computer system 800 upon which aspects of the illustrative embodiments may be implemented. Software system 900 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 900 is provided for directing the operation of computer system 800. Software system 900, which may be stored in system memory (RAM) 806 and on fixed storage (e.g., hard disk or flash memory) 810, includes a kernel or operating system (OS) 910.

The OS 910 manages low-level aspects of computer operation, including managing execution of processes, memory allocation, file input and output (I/O), and device I/O. One or more application programs, represented as 902A, 902B, 902C . . . 902N, may be “loaded” (e.g., transferred from fixed storage 810 into memory 806) for execution by the system 900. The applications or other software intended for use on computer system 800 may also be stored as a set of downloadable computer-executable instructions, for example, for downloading and installation from an Internet location (e.g., a Web server, an app store, or other online service).

Software system 900 includes a graphical user interface (GUI) 915, for receiving user commands and data in a graphical (e.g., “point-and-click” or “touch gesture”) fashion. These inputs, in turn, may be acted upon by the system 900 in accordance with instructions from operating system 910 and/or application(s) 902. The GUI 915 also serves to display the results of operation from the OS 910 and application(s) 902, whereupon the user may supply additional inputs or terminate the session (e.g., log off).

OS 910 can execute directly on the bare hardware 920 (e.g., processor(s) 804) of computer system 800. Alternatively, a hypervisor or virtual machine monitor (VMM) 930 may be interposed between the bare hardware 920 and the OS 910. In this configuration, VMM 930 acts as a software “cushion” or virtualization layer between the OS 910 and the bare hardware 920 of the computer system 800.

VMM 930 instantiates and runs one or more virtual machine instances (“guest machines”). Each guest machine comprises a “guest” operating system, such as OS 910, and one or more applications, such as application(s) 902, designed to execute on the guest operating system. The VMM 930 presents the guest operating systems with a virtual operating platform and manages the execution of the guest operating systems.

In some instances, the VMM 930 may allow a guest operating system to run as if it is running on the bare hardware 920 of computer system 800 directly. In these instances, the same version of the guest operating system configured to execute on the bare hardware 920 directly may also execute on VMM 930 without modification or reconfiguration. In other words, VMM 930 may provide full hardware and CPU virtualization to a guest operating system in some instances.

In other instances, a guest operating system may be specially designed or configured to execute on VMM 930 for efficiency. In these instances, the guest operating system is “aware” that it executes on a virtual machine monitor. In other words, VMM 930 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The illustrative embodiments may be implemented in a cloud computing environment, such as part of a backup service or the like. The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (Saas), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method for generating backups for a snapshot optimized sparse-aware file system, the method comprising:
initiating a backup of at least one file in the snapshot optimized sparse-aware file system;
generating a snapshot of the at least one file, wherein the snapshot is a sparse-aware snapshot storing only changes to the at least one file since a previous snapshot of the at least one file, and sparsity information;
generating a backup object based on the snapshot at least by storing the change data of the snapshot in the backup object, and representing the sparsity information of the snapshot as one or more logical offsets in the backup object; and
storing the backup object in a backup storage for later use in restoring the at least one file, wherein the one or more logical offsets comprise a first logical offset index that specifies a chunk in a storage space, and a second logical offset index that specifies a block within the chunk specified by the first logical offset index.

2. (canceled)

3. The method of claim 1, wherein the size of the blocks is equal to a minimum allocation size for a storage system of the at least one file.

4. The method of claim 1, wherein the sparsity information of the snapshot is further represented by a counter value associated with the second logical offset index, wherein the counter value specifies a number of contiguous blocks that are materialized starting with a block specified by the second logical offset.

5. The method of claim 1, wherein the sparsity information of the snapshot is further represented by a flag value indicating whether or not data corresponding to the second logical offset index is trimmed, initialized, or re-initialized data.

6. The method of claim 1, wherein the backup object stores the change data for a plurality of snapshots corresponding to changes to the at least one file since a previous backup object was generated.

7. A method for generating backups for a snapshot optimized sparse-aware file system, the method comprising:
initiating a backup of at least one file in the snapshot optimized sparse-aware file system;
generating a snapshot of the at least one file, wherein the snapshot is a sparse-aware snapshot storing only changes to the at least one file since a previous snapshot of the at least one file, and sparsity information;
generating a backup object based on the snapshot at least by storing the change data of the snapshot in the backup object, and representing the sparsity information of the snapshot as one or more logical offsets in the backup object; and
storing the backup object in a backup storage for later use in restoring the at least one file, wherein the snapshot is one of a plurality of snapshots in a hierarchical snapshot tree data structure corresponding to the at least one file, and wherein the backup object is one of a plurality of backup objects in a backup object tree data structure corresponding to the hierarchical snapshot tree data structure, and wherein restoring a file from a backup storage comprises traversing the backup tree data structure in a bottom-up manner to read data from the backup objects of the backup object tree data structure.

8. The method of claim 7, wherein there are fewer backup objects in the backup object tree data structure than snapshots in the hierarchical snapshot tree data structure.

9. The method of claim 1, wherein generating the backup object of the at least one file further comprises:
opening the snapshot of the at least one file for read access of a batch read session;
generating, for a logical space of the changes to the at least one file represented in the snapshot, individual extent sized requests;
batch processing the extent sized requests by a storage system;
allocating a buffer to store replies returned by the storage system based on the processing of the extent sized requests, wherein the data returned is sparsely packed in the buffer.

10. The method of claim 9, wherein generating the backup further comprises processing replies returned by the extent sized requests in a sequential manner, wherein no reply is returned if a region is sparse, wherein the sparsely packed data of the buffer constitutes the backup of the file.

11. The method of claim 9, wherein the batch processing comprises batching a set of extent sized requests, for a first set of one or more storage devices, by storage cells.

12. The method of claim 9, wherein generating individual extent sized requests comprises obtaining extent structures for the at least one file, and sending an input/output control message to each storage cell for extents that reside on the storage cell.

13. The method of claim 12, wherein each storage cell responds to the input/output control message with densely packed sparse data, a flag indicating if there is more data to be returned, and a token identifier identifying the batch read session.

14. The method of claim 9, wherein each extent sized request contains information detailing that the extent sized request is a sparse read between two snapshots specified by snapshot identifiers, wherein a first snapshot in the two snapshots is a last snapshot whose backup object already exists, and a second snapshot in the two snapshots is a the snapshot that is being backed-up in the backup object.

15. The method of claim 9, wherein extent sized requests that do not result in the return of any data are not included in the buffer.

16. The method of claim 9, wherein a sparseness of the at least one file is tracked via a two-level sparseness tracking scheme comprising a first level tracking that determines whether data is materialized at a data chunk level, and if the data chunk is not sparse, then utilizing a second level tracking that determines where, within the data chunk, data is materialized on a smallest granularity supported by the snapshot optimized sparse-aware file system.

17. One or more non-transitory computer-readable media storing instructions which, when executed by one or more processors, cause performance of:
initiating a backup of at least one file in the snapshot optimized sparse-aware file system;
generating a snapshot of the at least one file, wherein the snapshot is a sparse-aware snapshot storing only changes to the at least one file since a previous snapshot of the at least one file, and sparsity information;
generating a backup object based on the snapshot at least by storing the change data of the snapshot in the backup object, and representing the sparsity information of the snapshot as one or more logical offsets in the backup object; and
storing the backup object in a backup storage for later use in restoring the at least one file, wherein the one or more logical offsets comprise a first logical offset index that specifies a chunk in a storage space, and a second logical offset index that specifies a block within the chunk specified by the first logical offset index.

18. (canceled)

19. The one or more non-transitory computer-readable media of claim 17, wherein generating the backup object of the at least one file further comprises:
opening the snapshot of the at least one file for read access;
generating, for a logical space of the changes to the at least one file represented in the snapshot, individual extent sized requests;
batch processing the extent sized requests by a storage system;
allocating a buffer to store replies returned by the storage system based on the processing of the extent sized requests, wherein the data returned is sparsely packed in the buffer.

20. The one or more non-transitory computer-readable media of claim 19, wherein generating the backup further comprises processing replies returned by the extent sized requests in a sequential manner, wherein no reply is returned if a region is sparse, wherein the sparsely packed data of the buffer constitutes the backup of the file.

21. The method of claim 1, wherein the snapshot is one of a plurality of snapshots in a hierarchical snapshot tree data structure corresponding to the at least one file, and wherein the backup object is one of a plurality of backup objects in a backup object tree data structure corresponding to the hierarchical snapshot tree data structure, and wherein restoring a file from a backup storage comprises traversing the backup tree data structure in a bottom-up manner to read data from the backup objects of the backup object tree data structure.

22. The one or more non-transitory computer-readable media of claim 17, wherein the snapshot is one of a plurality of snapshots in a hierarchical snapshot tree data structure corresponding to the at least one file, and wherein the backup object is one of a plurality of backup objects in a backup object tree data structure corresponding to the hierarchical snapshot tree data structure, and wherein restoring a file from a backup storage comprises traversing the backup tree data structure in a bottom-up manner to read data from the backup objects of the backup object tree data structure
